(19) United States
(12) Patent Application Publication
(10) Pub. No.: US 2001/0045914 A1
(43) Pub. Date: Nov. 29, 2001

(54) Device and system for providing a wireless high-speed communications network

(76) Inventor: Philip Alan Bunker, Orem, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/792,577

(22) Filed: Feb. 23, 2001

Related U.S. Application Data
(60) Provisional application No. 60/184,987, filed on Feb. 25, 2000.

(51) Int. Cl. H01Q 21/00; H01Q 1/36

(52) U.S. Cl. 343/895; 343/893

(57) ABSTRACT

A device and system for providing a high-speed wireless communications network. The device includes a number of individual antennas that extend radially from a central axis of the device. The antennas are capable of producing circularly polarized signals. The device may be capable of directing a wireless signal to an individual antenna. A plurality of the devices may be installed and configured to operate as a high-speed wireless communications network. The communications network may connect computers. The network may be configured such that new nodes may be dynamically added and removed from the network. Each node of the network may execute a routing algorithm such that information may be efficiently exchanged between nodes inside and outside the communications network.

### RELATED APPLICATIONS

The present application claims priority to U.S. Provisional Application Ser. No. 60/184,987, entitled “Dynamic Airwave Network,” filed Feb. 25, 2000, which is hereby incorporated by reference.

### BACKGROUND OF THE INVENTION

1. Field of the Invention

The present invention relates to wireless data communications and more specifically to a high-speed mesh communications network.

2. Description of Related Background Art

Wireless communication technology continues to advance at a rapid pace. Wireless communication is being applied on a broad spectrum. On one end, wireless communications are used to send signals via satellite around the globe. On the other end, wireless signals are being used to send control signals from a remote control to a television.

Wireless communications involve sending and receiving electromagnetic signals. Electromagnetic signals (referred to herein as “radio waves”, or “signals”) may be distinguished by bands on a spectrum. The spectrum separates the signals based on the frequency of the signal. Common bands used for wireless communications include 49 MHz for remote controls, 88-108 MHz for FM radio, 824-849 MHz for cell phones, and others.

Due to the characteristics of radio waves, different transmission techniques may be needed for different frequencies. The way the signal is to be used may also impact the transmission technique used. For example, a signal may be passed from a transmitter to a receiver that is within a line of sight of the transmitter. Alternatively, a signal may be broadcast to many receivers at once from an elevated transmitter. Additionally, a signal may be directed in a particular direction to a particular receiver, sometimes referred to as narrow casting.

Generally, an antenna receives signals. An antenna converts the electromagnetic signal into an electrical signal that is detectable by a receiver. An antenna may also be used to transmit a signal. Often, an antenna is coupled to a transmitter and a receiver. Antennas that transmit in a particular direction are referred to as directional antennas. Other antennas transmit a signal in substantially all directions. These antennas are commonly referred to as omni-directional antennas.

Generally, wireless transmissions must deal with physical limitations. Signals travel from a transmitter to a receiver along a path. Ideally, the path is straight. However, most wireless environments do not allow for direct, straight paths. Often, there are one or more obstacles between the transmitter and the receiver. Depending on the frequency of the signal, the signal may bounce off or pass through the object. When a signal bounces off an object the reflected signal may still reach the receiver directly from the bounce or from additional bounces. However, the reflections may cause multiple signals to reach the receiver at the same time. The received signal may be the sum of all the reflected signals. Because the reflections may cause changes in amplitude and phase for each reflected signal, the signal that the receiver detects may be very different from the signal transmitted. The problem is called multipath interference, or multipath. Multipath may be significant enough that the amplitude of the original signal is altered.

Another problem with conventional wireless systems is absorption. As signals pass through an object, they may not have enough energy to exit and continue on the directed path. In these cases, absorption of the signal by the object causes a weak signal or no signal at all to reach the receiver.

Absorption is most pronounced in wireless systems operating in environments that have objects with high water content. So, bodies of water and living objects such as trees, foliage, and people present some of the largest absorption problems. One way to overcome absorption is to increase the power by which the signal is transmitted. Another solution may be to direct the signal to a receiver along a different path to avoid the obstacle. However, this does not solve the multipath problem.

Absorption also causes a limit on the range for wireless transmitters. As a signal passes through the air or objects, some of the energy of the signal is lost to the air and objects. A signal that passes through enough air or objects, particularly humid air such as a cloud, is limited in the distance the receiver can be from the transmitter and still detect the signal. This too may partially be resolved by increasing the power of the transmitted signal. But, the multipath problem remains.

Electromagnetic signals may be transmitted as electrical signals in wires, such as copper, cable, fiber optic, and the like. Wired signals generally do not have multipath problems and generally have a longer range than wireless signals. However, wired signals require the installation of a wire. The wire may be limited in how many electric signals may be sent on the wire at any given time.

Computer networks generally use wired connections. Each computer on the network has a physical wire connecting it to one or more other computers. Electronic signals, representing data, are sent between the computers. In this manner, the computers may communicate a variety of information, including transferring files, video information, sound information, and the like.

Individuals owning computers may desire to connect their computer to a global information network of computers (i.e., The Internet). Generally, the user dials a telephone number to allow a modem in their computer to connect to a computer at an Internet Service Provider (ISP). This kind of a wired connection is called a dial-up connection. Once a connection is made, the telephone wires are used to send electrical signals between the individual's computer and computers in the global information network.

Wire connections have various problems. Dial-up connections use the same telephone wire installed originally in the home for telephone conversations. Generally, the telephone line does not have enough wires or wires of the proper type to allow for high-speed transfers of computer information. Most dial-up connections allow a maximum of a 56 Kbps data transfer rate. This means each second the computer may transfer about 56,000 bits. Today, with the size of files, web pages, and other data being transferred across the Internet, this transfer rate is considered very slow. Generally, individuals desire faster connections to the Internet than dial-up connections can currently provide. Dial-up connections also have a delay between when the connection is initiated and when the user may interact with computers on the Internet. Users today desire a connection to the Internet that is available without the delay.

Generally, a household has a single telephone line. Wired dial-up connections use this line during the connection. This prevents telephone calls from being made to or from the home. This too can cause inconveniences for users.

There are solutions that allow an individual to connect a home computer to the Internet and still use the telephone. These solutions also offer higher data transfer speeds. Such solutions include a digital subscriber line (xDSL), a cable modem, or a satellite link.

The high-speed connection solutions have two major drawbacks. First, the equipment and price for the Internet connection service is generally very high. The equipment is very specialized to enable more data to travel over the telephone line to a central office within the telephone network. Once, the service is installed the user generally leases a dedicated line into their home. For this service, the user generally pays a higher price than with dial-up connections. For a satellite link the use of orbiting satellites is very expensive and a portion of the cost is generally reflected in the cost of the service. To use systems that utilize cable television cables, users may have to use a dial-up connection as a means of communication back to the network. Isolating networks and minimizing interference on these systems is very expensive. Similarly, a portion of the cost is generally reflected in the cost of the service.

Secondly, wired high-speed connection solutions such as xDSL and cable modems may not be available from a particular user's home or place of business. Generally, xDSL solutions rely on the telephone line of a user within a 3,000 foot radius of a telephone central office. Or, in the case of cable modems, cable television service must already be available to the home to allow use of cable modems. Remote areas may not have these preexisting services. To use these services the wire must then be installed. This means the neighborhood may be dug up to install the wires. Often the cost of installation for a single user does not outweigh the benefits for the user or an ISP desiring to offer the service.

As mentioned above, computers may be connected to form a network. The computers connected to the network are generally referred to as nodes. The manner in which the computers are connected is known as the network topology. Various topologies exist, such as bus, ring, star, and mesh. The network topologies indicate how one computer in the network is connected to one or more other computers. The connections between computers are referred to as links. The links involved for a source computer to transmit a signal to a destination computer make up the path.

The various network topologies have different problems. With bus, ring, and star networks a single point of failure exists. For a bus, if a segment of the bus is disconnected or fails, a set of computers on one side of the bus is unable to communicate with computers on the other side of the failure. Such a failure may be defined as a failure of the network topology to allow full inter-node communication. With a ring or star, if a segment of the ring fails, or the star hub fails, then none of the computers in the network can communicate with any other computers.

Generally, the trade-off for having single points of failure is that fewer physical connections between the computers must be maintained. The physical connections, wired connections, may be very expensive. Mesh topologies offer more reliability than other network topologies because there is not one single point of failure. However, if implemented using wired connections, a mesh topology can be very expensive.

Mesh topologies are fully connected if each computer, node, has a link to every other node. If not, then the mesh topology is referred to as a partial mesh network. By providing multiple links between computers, redundancy is built in to compensate for failures. If a link or node fails, the additional links may be used to carry on the inter-node communications. Additionally, the multiple links allow the network to avoid transmission bottlenecks. If certain nodes are getting a high volume of data traffic, the traffic may be routed through other links to avoid the bottlenecks.

In addition to interconnecting nodes in a specific manner, a network topology may also provide a means of coordinating node access to the media comprising the network. Each network topology must address how each node gains access to the media and how collisions on the media are handled. Generally, each network topology has set of rules, a protocol, that determines when a node can access the media to send or receive and how collisions on the media are handled.

In most network topologies these Media Access Control (MAC) protocols use an access protocol similar to Carrier Sense Multiple Access/Collision Detection (CSMA/CD). Under this protocol, the nodes trying to use the media detect a collision. They each then wait a random amount of time before trying to use the media to resend their data. If they detect a collision on the second attempt, they wait for the random time but twice as long. This continues until the colliding nodes receive a clear opportunity to transmit on the path. This technique is inefficient and known as ‘back off’. While the nodes are waiting their random back off times, the network links are sitting idle.

The limitations associated with collision detection and avoidance media access control protocols, could be solved through employing a time-based means of media access. However, media access protocols associated with most wireless networks do not manage network access or collisions in a synchronous manner.

Electrical signals transmitted between nodes of a network may be organized into data elements, or bits, of ones and zeros. A set of bits comprises a data packet. Each packet represents a message or a portion of a message that a source computer desires to send to a destination computer. Each network must also have one or more additional higher level network protocols for transmitting data packets between nodes, from source nodes to destination nodes.

Common higher level network protocols include Open Shortest Path First (OSPF), Routing Information Protocol (RIP), and various others. These protocols may be implemented in hardware or software. Devices that route data packets along certain paths within the network are called routers. A router may comprise hardware, software, or a combination of the two. One router cooperates with one or more other routers on the network to follow the routing rules of the protocol to deliver data packets from source nodes to destination nodes.

Computer network communications may be implemented using wireless technologies. However, problems such as range, absorption, and multipath must be resolved such that the reliability necessary for computer communications may be achieved. A mesh network topology may be implemented with wireless links.

Wireless communications networks for computer communications do exit. However, such networks generally operate on an overall point-to-point or point-to-multipoint architecture. Typically, a point of presence (POP) is connected to a global information network. The POP tranceives signals with a number of nodes. One problem with this wireless approach is that there is a single point of failure. If the POP fails, then none of the nodes may communicate on the network. Additionally, point-to-point wireless solutions may suffer from bottleneck problems as all the communications between the nodes and the network must go through the single POP. Even communications between nodes serviced by the POP must send their signals through the one POP. Limitations such as a single point of failure may limit the ability of a wireless point-to-point network to grow through adding new nodes.

An additional problem with point-to-point wireless networks is that the total throughput of data through the POP must be shared by all nodes connected through the POP. Generally, a point-to-point wireless POP uses a large antenna array located on tower to handle communications for the area covered by the POP. Typically, each POP transmits signals at a radius between three to five miles, or roughly an area between twenty five and seventy five square miles. Currently, each wireless POP operates at data rates of approximately eleven mega bits per second (Mbps). If only one node were connected to the POP, that node would enjoy a data rate equal to the maximum data rate supported by the POP. As each additional node is added to the POP, the total available data rate of the POP is shared among all of the nodes.

An additional problem with point-to-point wireless networks is that the area served by each POP needs to be large in order to spread the costs of the transmission power and the POP among the various nodes.

An additional problem with point-to-point wireless networks is that the areas serviced by the POP do not employ frequency reutilization through a cell structure, or if they do employ a cell structure, they are not capable of aligning the boundaries of the cell to avoid interference with other cells. Generally, wireless point-to-point and point-to-multipoint networks operate within a single frequency, or deploy a means of creating channels within the frequency utilizing expensive modulation technologies such as spread spectrum, frequency shift keying, multiple carrier, phase shift keying (PSK), amplitude shift keying (AKS) or other techniques known in the art.

An additional problem with point-to-point wireless networks is that, if they do deploy a cell structure, the boundaries of the cells cannot be changed without changing the equipment at the POP. To juxtapose two cells would require either changing the antenna array or connecting part of the antenna array to a different transceiver.

Point-to-multipoint wireless communications networks are generally organized according to a star topology. This may present problems as each node then only has a single path between it and the POP. If foliage or other obstacles block this path, then nodes may not be able to function on the network. Generally, wireless networks do not provide a mechanism for avoiding natural obstacles blocking the communications path.

Accordingly, what is needed is a device and system for providing a wireless high-speed communication network. What is also needed is a device and system for providing a wireless high-speed computer network. Additionally, what is needed is a device and system for providing a wireless high-speed communication network which includes a device which significantly reduces the effects of multipath. What is also needed is a device and system for providing a wireless high-speed communication network which allows a signal to be directed in a particular direction or at a particular strength to overcome absorption problems. What is also needed is a device and system for providing a wireless high-speed communication network that properly allocates available spectrum or bandwidth within a cell, that dynamically sizes the cell, and that defines the structure of a plurality of cells to avoid inference among cells participating in the network. Additionally, what is needed is a device and system for providing a wireless high-speed communication network which supports a high computer network data transfer rate, is always connected to the network, and is flexible enough to handle growth of the network. Moreover, what is needed is a device and system for providing a wireless high-speed communication network which is non-intrusive to install and involves minimal installation, equipment, and service costs. What is also needed is a device and system for providing a wireless high-speed communication network which allows for a reliable and inexpensive mesh network topology for networking computers. The present invention provides such a device and system.

### BRIEF DESCRIPTION OF THE DRAWINGS

Non-exhaustive embodiments of the invention are described with reference to the figures, in which:

FIG. 1 is a perspective view of a device that may be used in a system for providing a wireless high-speed communications network in one embodiment of the present invention;

FIG. 2 is cross-sectional view taken along line 2 of FIG. 1 illustrating internal components of a device used within one embodiment;

FIG. 3 is a pictorial depiction illustrating one embodiment of a computer network configured according to the present invention;

FIG. 4 is a diagram of the network of FIG. 3 illustrating possible links between nodes of a mesh network;

FIG. 5 is a pictorial depiction, with a cut-away wall, of one configuration of a node within an embodiment of a wireless network of the present invention.

### DETAILED DESCRIPTION OF THE PREFERRED EMBODIMENTS

The present invention solves the foregoing problems and disadvantages with a device and system for a high-speed communication network. In one embodiment, a multidirectional antenna array is provided. The antenna array includes more than one, for example twelve, conductive planar segments. Each conductive planar segment is connected to a conductive helical antenna that extends perpendicularly from the planar segment. Each antenna is capable of generating a circularly polarized signal. A transceiver is also electrically connected to each antenna. The planar segments are attached to each other such that they define a polygon shape and direct their respective antennas outward from the polygon. Preferably, the polygon is a dodecagon of 12 equal length sides. The transceiver may be capable of selecting an antenna for use in transmitting or receiving a signal in a particular direction.

In one embodiment, a plurality of computers may be connected to each other in a network using antenna arrays to wirelessly send signals from one computer to the next. One computer on the network may include a wired connection to the Internet. The plurality of computers may be organized in a mesh topology to provide greater reliability. The network may be capable of adapting to network nodes that are added or removed dynamically.

In another embodiment, the network nodes may include a router that cooperates with other routers and network devices to reliably send information between the network nodes. The router may include hardware, software, or their combination to provide the necessary functionality. The routers may execute a routing algorithm to efficiently establish a communication path between a source node and a destination node.

In one embodiment, a group of routers may cooperate either independently or through a POP to adjust power on one or more antennas of each participating node's antenna array to adjust the size of the cell in which the nodes are participating to avoid interference with other nodes in the network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, physical structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Referring now to FIG. 1, there is illustrated an antenna array 100 for transmitting and receiving high-speed wireless electromagnetic signals. The antenna array 100 includes at least two planar segments 102. Preferably, three or more segments 102 are connected such that they form a polygon shape around a central axis 104 of the antenna array 100. Alternatively, two planar segments 102 may be connected to each other and a brace (not shown) such that a polygon shape is defined.

The size, shape, and number of segments 102 may determine the size and shape of the polygon. Preferably, the segments 102 are planar rectangular pieces of conductive material such as metal. Alternatively, the segments 102 may be formed from various materials including plastic, wood, ceramic and the like, which have a conductive material secured to the outward facing surface of the segment 102. Preferably, the segments 102 all have substantially the same size. In one embodiment, the segments 102 are squares with sides of about 2 inches. Alternatively, the segments 102 are of various shapes and sizes such as squares, triangles, diamonds and the like. The segments 102 may be joined end to end such that an exterior plane 106, or surface 106, of the segment 102 runs parallel to and faces away from the central axis 104. The ends of the segments 102 join at an angle that will form a polygon having the same number of sides as the number of segments 102. Preferably, the segments 102 are joined by welding. Alternatively, the segments 102 may be secured using some form of insulating material. Additionally, the segments 102 may be fabricated by bending a single planar piece of material into the polygon shape.

Each segment 102 is preferably connected to an antenna 108 that extends away from the exterior plane 106. Preferably, each antenna 108 is centrally located within the exterior plane 106 of a corresponding segment 102. Alternatively, the antenna 108 may be attached at any point within the exterior plane 106.

By arranging the antennas 108 and segments 102 to define a polygon, the antenna array 100 is capable of sending and receiving wireless signals in multiple directions. The location of each antenna 108 about the central axis 104 defines a different direction in which wireless signals may be sent and received.

Generally, the components of the antenna array 100 are made of conductive material such as iron, aluminum, copper, gold, silver, and other like materials. The antenna array 100 is generally installed on the rooftop of a building, home, or other structure. Generally, the higher the antenna array 100 is installed, the more consistent and reliable the antenna array 100 will function. However, the antenna array 100 of the present invention may be installed at the same height as trees and other foliage and still function properly. Preferably, the antenna array 100 is installed such that the central axis 104 runs perpendicular to the horizon. In this manner, the antenna array 100 is capable of sending and receiving signals in multiple directions about the house or building upon which the array 100 is installed.

In one embodiment, the antenna array 100 may include a top 110 and a bottom 112. FIG. 1 illustrates an antenna array 100 with the bottom 112 facing up. The top 110 and bottom 112 may also be made of conductive material. Alternatively, the top 108 and bottom 112 are made from material that has high durability when exposed to the elements, such as fiberglass. The top 110 and bottom 112 serve to provide structure for holding the segments 102 in a proper configuration. The top 110 and bottom 112 may be welded to the top and bottom edges of the segments 102. Alternatively, the top 110 and bottom 112 may be secured using some insulating material. Preferably, the top 110 and bottom 112 are of the same size and shape as the polygon defined by the segments 102. The top 110, bottom 112 and segments 102 cooperate to house internal components of the antenna array 100.

In an alternative embodiment, the antenna array 100 is housed in a housing comprising a top enclosure (not shown) and a bottom enclosure (not shown). The two enclosures may be sized to completely enclose a respective top and bottom half of the antenna array 100. The enclosures may be joined along their edges to fully enclose the antenna array 100, including the antennas 108. Alternatively, the enclosures may include holes to allow the antennas 108 to protrude from the edges of the enclosures.

The bottom 112 may include a coaxial cable connection 114. The coaxial cable connection 114 may also be located on the top 110. The coaxial cable connection 114 electronically connects the antenna array 100 to a coaxial cable. Alternatively, a different kind of connection 114 may be used such as twisted pair connections.

For illustrative purposes, FIG. 1 also includes a horn antenna 208. The horn antenna 208 illustrates an alternative embodiment for the antennas 108. Horn antennas 208 are described in more detail below. In an embodiment that uses horn antennas 208 the segments 102 may not be used for signal transmission or reception. Instead, the segment 102 may serve as structural support for the horn antenna 208. Alternative support structures may be used to configure a plurality of horn antennas 208 about a central axis 104.

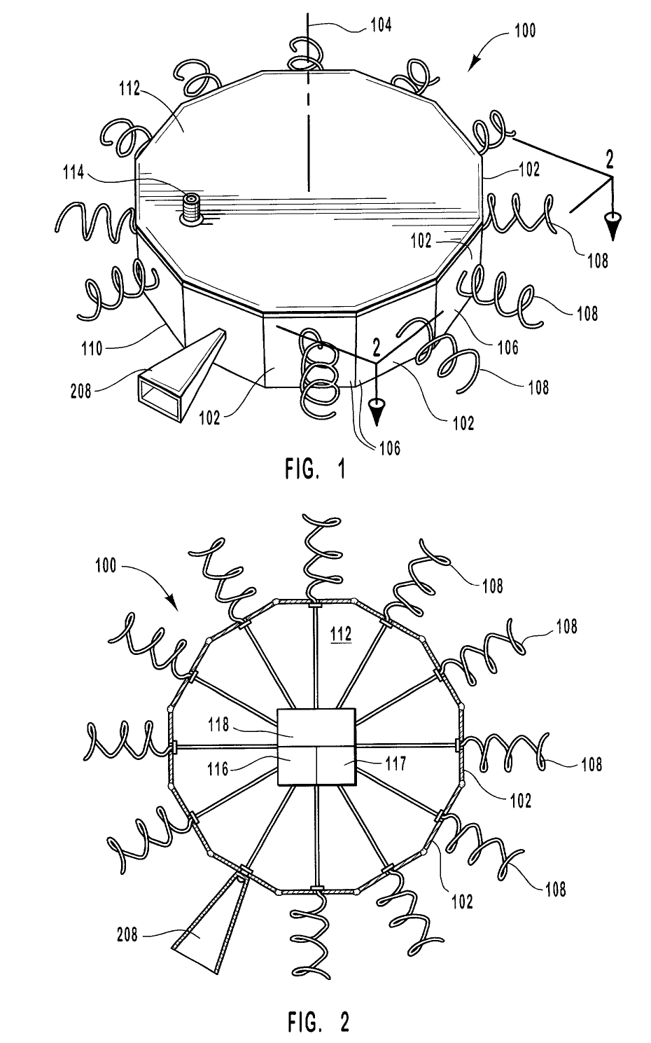

Referring now to FIG. 2, an antenna array 100, and internal components of one embodiment is illustrated in cross-section along line 2-2 in FIG. 1. For illustrative purposes, twelve segments 102 are shown. However, the antenna 100 may comprise two, three, four, or any plurality of segments 102. Also by way of illustration, the segments 102 are shown having equal lengths such that the segments 102 form an equilateral dodecagon.

Each antenna 108 provides an electromagnetic reception and transmission structure. Preferably, the antenna 108 is made from a conductive wire that is wound and bent to form a helix. The diameter of the helix is preferably consistent along the length of the antenna 108. Alternatively, the helix diameter may vary for each wind in the helix.

The length of the antenna 108 may vary. Generally, the frequency of signals exchanged using the antenna 108 is directly affects the length of the antenna 108. Additionally, the frequency of the signals may affect the size of the segments 102. In a preferred embodiment, the antenna 108 is between about 1-2 inches to allow a range of about 1 mile in each direction in which an antenna 108 extends. Preferably, each antenna 108 of the array 100 is of the same length. Alternatively, individual antennas 108 may vary in length.

The antenna 108 allows for signals to be transmitted in a pattern such that the signal is circularly polarized. Similarly, the antenna 108 is capable of receiving signals which are circularly polarized. Preferably, one antenna array 100 transmits (the source) signals to a second receiving antenna array 100 (the destination). Because the source and destination antennas 108 are configured to send and receive circularly polarized signals the antennas 108 are capable of deciphering a signal from a source 100 as opposed to noise signals or multipath reflection signals. By polarizing the transmitted signal and the receiving signal, the effects of multipath may be minimized. Additionally, the ability to direct a signal through a particular antenna 108 and at a particular power, each discussed below, also aids in minimizing multipath.

In the illustrated embodiment, the antennas 108 are helical in shape. The helical shape produces the circular polarization. Alternatively, a circular polarizing horn antenna 208 may be used rather than the helical shaped antenna 108. Horn antennas 208 are well known for their ability to produce circularly polarized signals. Other antennas 108 capable of creating a circularly polarized signal are contemplated within the scope of this invention.

Referring still to FIG. 2, the antenna array 100 includes a transceiver 116. The transceiver 116 transmits and receives electrical signals using the antennas 108. The transceiver 116 may interpret signals that are received on a particular antenna 108. The transceiver 116 also directs a signal to a particular antenna 108.

The transceiver 116 preferably modulates the communication data with a carrier frequency to enable transmission thereof to a second antenna array 100 using techniques well known in the art. For example, the transceiver 116 may operate according to the IEEE 802.11a or 802.11b Wireless Networking standards, the “Bluetooth” standard, Infrared Data Association (IrDA), Consumer Electronics Bus (CEBus), or according to other standard or proprietary wireless techniques. Modulation techniques may include spread spectrum, frequency shift keying, multiple carrier, phase shift keying (PSK), amplitude shift keying (AKS) or other techniques known in the art.

Communication data may include a variety of signals, such as voice, data, control, and other signals that may be transmitted electronically. Additionally, the communication data may be in analog or digital formats. In one embodiment, the antenna array 100 may be used to transmit and receive voice data. In another embodiment, the antenna array 100 may be used to transmit computer network communication data. In yet another embodiment, the antenna array 100 may be used to send and receive a variety of data types and formats.

To achieve modulation and transmission, the transceiver 116 may include various additional components not specifically illustrated but well known in the art. For example, the transceiver 116 may include a source encoder to reduce the amount of bandwidth required, a channel encoder to modulate the communication data with a carrier wave, and a digital signal processor. The transceiver 116 may further include an amplifier to increase the transmission signal strength to an appropriate power level. Similarly, the transceiver 116 may further include an amplifier for increasing the strength of received signals, and a decoder for separating and demodulating the communication data from the carrier signal.

In one embodiment, the transceiver 116 is configured to transmit and receive digital signals. As such, the transceiver 116 may include an analog-to-digital converter (ADC) to convert analog signals into digital signals. Likewise, the transceiver 116 may include a digital-to-analog converter (DAC) to generate analog signals from digital signals. The present invention contemplates both the use of analog and digital transmissions to and from the antenna arrays 100.

In one embodiment, the transceiver 116 includes a multiplexor (not shown) and a demultiplexor (not shown). The demultiplexor allows the transceiver 116 to isolate signals received on each antenna 108 to particular transmission channels. By separating the signals of each antenna 108 to a particular transmission channel, the transceiver 116 is capable of ‘listening’ to antenna arrays 100 located in particular directions in relation to the antenna array 100 housing the transceiver 116. Similarly, the multiplexor (not shown) allows the transceiver 116 to send signals through a particular antenna 108 pointing in a desired direction. Alternatively, a switch (not shown) may be used to distinguish one antenna from another.

In a preferred embodiment, the antenna array 100 includes a processor 117. The processor 117 is electronically connected to the transceiver 116. The processor 117 may dynamically select one of the antennas 108 through which an electromagnetic signal may be sent. Because each antenna 108 is directed in a different direction, the processor 117 allows the antenna array 100 to send signals in particular directions. Additionally, the processor 117 may dynamically set the amount of power used to transmit using the particular antenna 108. By dynamically setting the power used for a transmission, the processor 117 is capable of compensating for foliage or other obstacles blocking a particular direction. Different amounts of power may provide the signal the strength needed to overcome absorption problems. Additionally, the processor 117 may be coupled to multiplexor (not shown) and a demultiplexor (not shown) to allow the processor 117 to isolate a single antenna 108 for sending or receiving a transmission.

Multiplexing and demultiplexing signals is well known in the art. Multiplexing methods include Frequency Division Multiplexing (FDM), Time Division Multiplexing (TDM), Statistical Time Division Multiplexing (STDM), Wavelength Division Multiplexing (WDM), and others. However, using a transceiver 116 or a processor 117 to multiplex and demultiplex allows the antenna array 100 the flexibility of changing the direction in which a single transmission signal is sent and/or received. The antenna array 100 is capable of avoiding obstacles to the signal.

In this manner, one embodiment of the present invention is capable of narrow casting circularly polarized signals from a source antenna array 100 to a destination antenna array 100 in any one of a plurality of directions. Likewise, a destination antenna array 100 is capable of receiving circularly polarized signals from source antenna arrays 100 in any one of a plurality of directions. The circularly polarized signals allow each antenna array 100 to send and receive signals with minimal multipath interference. Additionally, the ability to change the power used to send each signal allows the antenna array 100 to minimize signal absorption problems.

In one embodiment, the antenna array 100 includes receiver 118. In a preferred embodiment, the receiver 118 is a global positioning system (GPS) receiver 118. The receiver 118 may provide two functions. First, the receiver 118 may allow an antenna array 100 to identify where it is located geographically. In a preferred embodiment, information such as altitude, latitude, and longitude may be transmitted to a GPS receiver 118 from a GPS transmitter (not shown). The location information may be used to organize a communication network utilizing a plurality of antenna arrays 100. Location information may be used to efficiently determine how information should flow between antenna arrays 100 in a communication network.

Secondly, the receiver 118 may be used to synchronize a plurality of antenna arrays 100 to a common clock, or time sequence. The receiver 118 may receive a synchronization signal. Generally, a synchronization signal is a wireless signal that allows the receiver 118 and/or other components of a system to adjust their internal clocks to the same time sequence. The synchronization signal may originate from a global positioning satellite. Alternatively, one or more other electromagnetic transmitters may transmit a synchronization signal. Synchronizing a plurality of antenna arrays 100 may also be used to organize a plurality of antenna arrays 100 into a communications network, described in more detail below.

The receiver 118 is preferably located with the transceiver 116 on a printed circuit board (PCB). Alternatively, the receiver 118 and transceiver 116 may be separate components in the antenna array 100. The receiver 118 and transceiver 116 may be secured to the bottom 112 at a central location. Alternatively, they may be located outside the antenna array, or mounted to one or more segments 102.

In a preferred embodiment, the antenna array 100 is configured to transmit and receive electromagnetic signals within a frequency band of about 5.727 GHz to 5.875 GHz. The antenna array 100 is capable of being powered at variable power levels. However, one skilled in the art will recognize that changes to the size and components used in the antenna array 100 may require changes in the amount of power used for transmissions.

In one embodiment, the antenna array 100 operates at power levels between about 0-+30 dBm, or 1 milliwatt-1 watt. Alternatively, the antenna array 100 may be powered by more than 30 dB. The antenna array 100 is configured to operate using different power levels for each transmission. Additionally, the antenna array 100 may direct different amounts of power to a particular antenna 108. Preferably, the direction and variation of power to an antenna 108 is accomplished using the transceiver 116.

The ability to vary the amount of power allows a source antenna array 100 to compensate for obstacles between it and a destination antenna array 100. For example, if a tree or other foliage obstructs the space between one antenna 108 of the source 100 and a second antenna 108 of the destination 100, the source antenna array 100 may increase the power used to transmit on the antenna 108 that is pointed in the direction of the obstacle. Increasing the power may allow the signal to pass through the object to the second antenna 108 of the destination 100. Additionally, if a transmitted signal is not being received due to the distance between a source antenna array 100 and a destination antenna array 100 the power level may be increased to compensate.

Likewise, the power levels may be reduced to avoid interference between two neighboring antenna arrays 100. For example, a plurality of antenna arrays 100 may be installed within a one-mile square geographic area. The one-mile square area may define a first geographic network cell in which all the arrays 100 operate at the same frequency. An adjacent second cell, may include a second plurality of arrays 100 which operate at a different frequency. Additionally, arrays 100 within a network cell may operate using a modulation protocol which is different from an adjoining network cell. Arrays 100 which lie along the boundaries of the first cell and second cell may transmit signals which interfere with each other. Therefore, the arrays 100 along the boundaries may be configured such that the power level is reduced on antennas 108 which direct toward an adjacent cell. In this manner, the power of the arrays 100 may be managed to provide a more reliable network of inter-communicating antenna arrays 100.

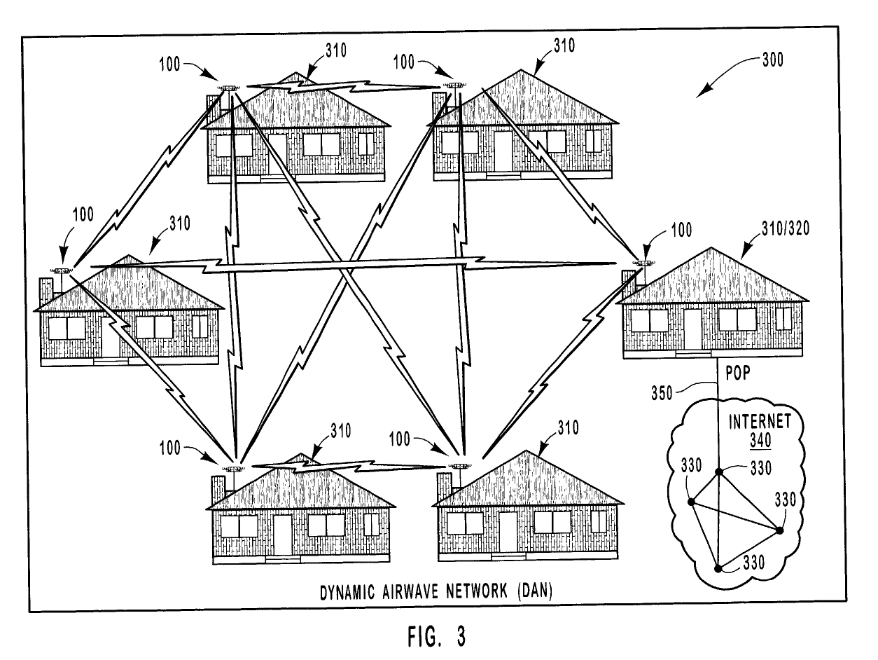

Referring now to FIG. 3, one embodiment of a high-speed communications network 300 is illustrated. The network 300 comprises a plurality of antenna arrays 100 configured to communicate wireless signals to each other. Preferably, the antenna arrays 100 are mounted on the roof of a house, building or other structure. Alternatively, the antenna arrays 100 may be mounted on an antenna tower or other like structure such that the antenna arrays 100 are installed with minimal obstacles between them. However, obstructions such as trees and other foliage may be allowed to obstruct one or more antenna arrays 100 without impacting the ability of signals to travel from one antenna array 100 to another.

The separation between antenna arrays 100 is preferably about the same as the distance between adjacent homes in a modem subdivision. However, larger distances of separation between antenna arrays 100 are also contemplated within the scope of this invention. Preferably, the antenna arrays 100 are installed such that at least one antenna 108 of a first antenna array 100 is capable of transmitting and receiving signals from an antenna 108 of a second antenna array 100.

Each antenna array 100 may be connected to a corresponding communication device (not shown), such as a telephone, personal digital assistant (PDA), television, set top box, computer, or other consumer electronic device configured to send and receive electronic signals with other like devices. Each communication device may comprise a node 310 of communication network 300.

Preferably, each antenna array 100 is connected to a computer network node 310. The node 310 may comprise a personal computer (not shown), a router, a gateway, and other similar network or communications devices. One node 310 connected to an antenna array 100 may serve as a gateway 320.

A gateway 320 generally connects two networks 300. The gateway allows nodes 310 within one network 300 to conduct two-way communication with external nodes 330. External nodes 330 are those that are external to a particular network 300.

A gateway 320 may be used to connect one wireless network 300 to a second network 340. The second network 340 may comprise a local area network (LAN), wide area network (WAN), or the like. In a preferred embodiment, the gateway 320 connects the network 300 to external nodes 330 in a global information network 340, such as the Internet 340. The gateway 320 may be connected to a point of presence (POP) or Internet Service Provider (ISP) to establish the connection to the Internet 340. Additionally, the network 300 may include more than one gateway 320. Each gateway 320 may connect the network 300 to the Internet 340, or another network 300.

The connection 350 between the gateway 320 and the Internet 340 is preferably a high bandwidth physical connection such as fiber optic cable, coaxial cable, or other similar connections. Alternatively, the connection 350 may be a wireless electromagnetic connection.

One or more nodes 310 may define a network cell 300. A network cell 300 may be characterized as a portion of a network 300. Alternatively, the network cell 300 may be defined as the whole network 300. For example, the network 300 illustrated in FIG. 3 may represent a network cell 300. A network 300 may also be organized as a plurality of network cells 300.

Networks 300 are generally organized into network cells 300 to facilitate management and control of signals entering and exiting the network 300. For example, different network cells 300 may utilize different transmission frequencies and/or modulation protocols. In this way, interference between network cells 300 may be avoided.

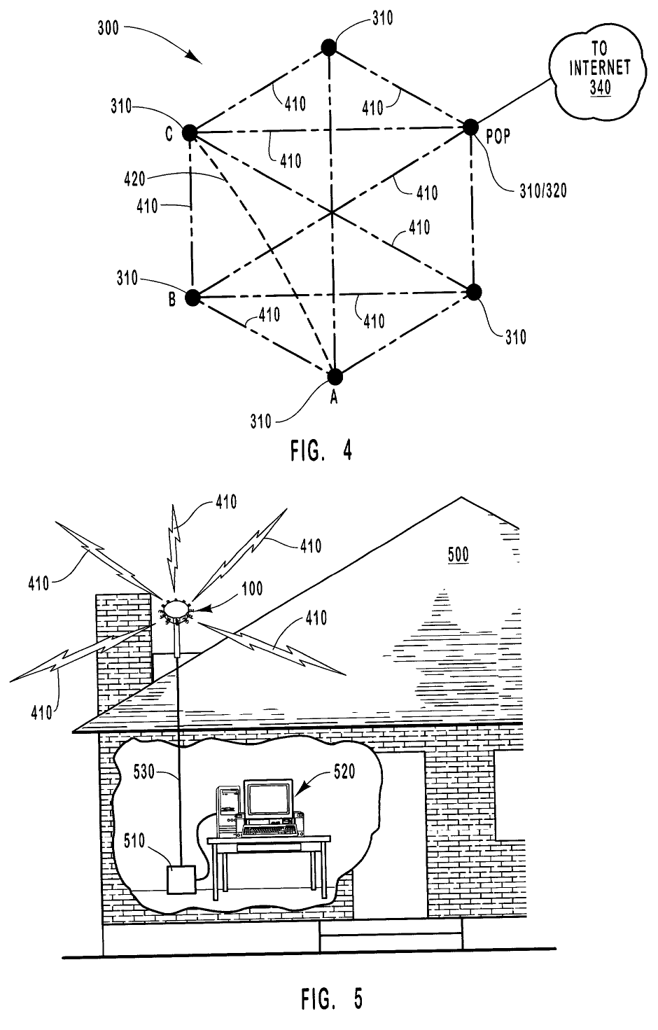

Referring now to FIG. 4, the network 300 of FIG. 3 is illustrated as a graph to show a network topology of one embodiment of the present invention. A network topology refers to the way the nodes 310 are connected to allow a signal to pass from one node 310 to another in the network 300. FIG. 4 illustrates nodes 310 and links 410. A link 410 is a direct wired or wireless connection between two nodes 310. FIG. 4 specifically illustrates a mesh network topology.

Signals in a network 300 travel from a source node 310 to a destination node 310 along a path 420. A path 420 is one or more links 410 which the signal traverses to reach the destination node 310. For example, the mesh network in FIG. 4 is a partial mesh network because node A does not have a direct link 410 between it and node C. Node A may still communicate with node C by passing the signal to one or more intermediate nodes 310. For example, the signal may be passed from node A to node B and from node B to node C and vise versa. The direct links 410 between node A and node B and node B and node C comprise one possible path 420 between node A and node C. Alternatively, multiple different paths 420 may be taken to send signals between node A and node C.

Nodes 310 may communicate using antenna arrays 100. The antenna arrays 100 may be installed such that each antenna array 100 may operably communicate by a link 410 with at least two other antenna arrays 100 according to a mesh topology. In a mesh topology, or mesh network, at least two nodes 310 have at least two links 410 connecting the nodes 310 to other nodes 310. At least two nodes 310 are capable of communicating with another node 310 in the network 300 using more than one link 410. In a fully connected, or full mesh topology, each node 310 is capable of communicating with every other node 310 using a unique link 410.

The partial mesh network of FIG. 4 provides advantages over other network topologies. For example, a mesh network 300 prevents a single point of failure. If a node 310 or link 410 within a mesh network 300 fails, signals may simply be routed through other nodes 310 such that each node 310 may still operably communicate with each other node 310. Conventionally, mesh networks 300 are implemented only when high reliability is required because of the high cost of establishing multiple links 410 between nodes 310. Generally, each link 410 is implemented with a physical connection. However, using an antenna array 100 according to one embodiment of the present invention, multiple links 410 may be established between nodes 310 at minimal cost. The links 410 are wireless. In one embodiment, nodes 310 may be fully connected.

Multiple links 410 between nodes 310 allow the network 300 to simply use a different path 420 if the direct link 410 between two nodes 310 is blocked by trees, buildings, or other obstacles. In one embodiment, the power directed to an antenna 108 pointing in the direction of the direct link 410 between two nodes 310 may be increased to send a signal through the obstacle. However, if increasing the power is not successful, the source node 310 may simply transmit along a different path 420 to one or more intermediate node(s) 310 which have an unobstructed direct link 410 to the destination node 310.

Multiple links 410 allow for many more paths 420 between any two nodes 310 in the network 300. Multiple links 410 and/or nodes 310 must fail before a mesh network 300 becomes disconnected. In a disconnected network 300, one or more nodes 310 are unable to communicate with one or more other nodes 310 in the same network 300.

In one embodiment, a plurality of antenna arrays 100 may be configured in a mesh network 300. Due to use of a high frequency bandwidth of about 5.7 GHz, sophisticated modulation techniques, such as QAM broadband modulation, and an ability to direct variable power along a particular path 420 in the network 300, this embodiment is capable of transferring data across ten channels between nodes 310 at a rate of between twenty to thirty Mega bits per second (Mbps). Those of skill in the art readily recognize that the channel allocations and corresponding data rates may be modified either by hardware or software modifications. In one embodiment, one channel may be reserved to provide a more reliable high quality dedicated transfer rate.

Referring now to FIG. 5, one embodiment of a node 310 within the scope of the present invention is illustrated in a pictorial depiction. The node 310 is electronically connected to an antenna array 100 described in detail above. Node 310 refers generally to communication components located at a particular geographic location, such as a home 500, which are configured to operate in a network 300.

In FIG. 5, the node 310 comprises a router 510. The router 510 is preferably electronically connected to a personal computer 520. Alternatively, the router 510 may be connected to local area network (LAN), or other network 300 of communication devices within a home 500 or business 500. Additionally, the router 510 may be connected to a corresponding communication device 520, shown in FIG. 5 preferably as a computer 520. Alternatively, the communication device 520 may comprise a telephone, personal digital assistant (PDA), television, set top box, or other consumer electronic device configured to send and receive electronic signals with other like devices.

Those of ordinary skill in the art will recognize that the router 510 may comprise a separate electronic component as illustrated, may be a PC card installed within the computer 520, or may comprise software operating on the computer 520 using a network connection to the antenna array 100. These and other like implementations of the router 510 are contemplated within the scope of the present invention.

Generally, the router 510 is connected by a coaxial cable 530 to the antenna array 100. The cable 530 carries communication data between the router 510 and the antenna array 100. Additionally, the cable 530 may carry control signals for the transceiver 116 (Shown in FIG. 2). The cable 530 also carries signals from the receiver 118 (See FIG. 2) of the antenna array 100 to the router 510. Alternatively, other wired or wireless connections 530, such as fiber optic cable, or network cable may be used.

The personal computer 520 may comprise a standard consumer computer 520 executing a variety of computer operating systems such as Windows®, Macintosh®, Linux, or other operating system. The computer 520 includes hardware and/or software configured to communicate with the router 510 using well known networking protocols such as transmission control protocol/Internet protocol (TCP/IP), NETBIOS extended user interface (NETBEUI), Internetwork Packet Exchange/Sequenced Packet Exchange (IPX/SPX), and the like.

In one embodiment, the router 510 enables the computer 520 to communicate with other computers 520 and devices 520 in the network 300 as well as external nodes 330 in other networks 300. Nodes 310 of network 300 communicate with each other by sending data elements which are bundled together in data packets (not shown). A data packet includes a certain number of data bits. The number of bits is generally determined by the networking protocol being used. The number of bits may be fixed or variable. Generally, a data packet also includes an address. The address indicates which node 310 the packet is to be delivered to. The address may comprise an Internet protocol address (IP), media access control address (MAC), uniform resource locator (URL), and the like.

Additionally, the router 510 cooperates with other routers 510 in the network 300 to manage the flow of communication data within the network 300. Data packets are sent from node 310 to node 310 via links 410. In order to operably deliver a data packet from a source node 310 to a destination node 310, the routers 510 of the network 300 generally follow a particular protocol, such as the Border Gateway Protocol 4 (BGP-4), Open Shortest Path First 2 (OSPF-2), Routing Information Protocol (RIP), and the like. Each of these protocols and others are contemplated within the scope of the present invention.

The routing protocols generally define the rules for communication that represent a larger architecture of the network 300. Nodes 310 in a network 300 may be implemented to regard each other according to different social models. For example in an alternative embodiment, one node 310 may treat one or more other nodes 310 as slaves. The slave nodes 310 may regard the single node 310 as a master. These nodes 310 would then operate under a client-server model.

In a preferred embodiment, each node 310 regards the others as equals or peers. The nodes 310 then communicate using a peer-to-peer architecture. With a peer-to-peer architecture, each node 310 is regarded as having equal capabilities and responsibilities for management and control of the network 300. In the illustrated embodiment, these capabilities and responsibilities are allocated to the router 510.

Referring still to FIG. 5 and generally to FIGS. 3 and 4, the nodes 310 generally need to have information about the network 300 topology. The information may include which links 410 exist, which nodes 310 are active within the network 300, and the addresses for one or more nodes 310 in the network 300. Generally, this information is stored at each node 310 in a routing table. The amount of information each node 310 needs to track about the network topology varies depending on the networking and routing protocols used in the network 300. From the information about the network 300, a router 510 may then send data packets along particular links 410 and/or paths 420 between a source node 310 and a destination node 310. Determining which path 420 should be used is generally performed by a routing algorithm, described in more detail below.

According to one embodiment, the network topology information, or routing information may be gathered by each node 310 and then distributed to the other nodes 310 in the network 300. For example, the router 510 of a node 310 may conduct a data collection phase during which the router 510 signals the transceiver 116 to send a signal through each antenna 108 in turn. The router 510 may then ‘listen’ for a test response from neighboring nodes 310 which received the signal. If a response is not detected, the power for the particular antenna 108 may be increased to compensate for foliage between the two nodes 310 along that potential link 410. Then, if no response is received, the router 510 may then conclude that no link exists between the test antenna 108 and another node 310. The response from a node 310 receiving a test signal may be the receiving node's 310 network address. This address may then be recorded by the sending node. Following the data collection phase each node 310 may conduct a data exchange phase in which each node 310 transmits its routing information to all its neighboring nodes 310 across direct links 410. In this manner, each node 310 may identify and store the network topology.

Networks 300 may be implemented such that nodes 310 operate using synchronized or non-synchronized clocks. Synchronizing clocks at each node 310 allows the nodes 310 to communicate using a network protocol that orders communications based on time segments. By synchronizing the clocks, transmissions along the links 410 may be ordered such that collisions of data packets on the network 300 are avoided. Collisions are discussed in detail earlier. Collision detection and recovery generally makes a network operate less efficiently than if collisions do not occur.

In one embodiment, the nodes 310 comprise clocks, which are synchronized. The clocks may be synchronized using a synchronization signal received using a GPS receiver 118 in the antenna array 100. The synchronization signal may be generated by a GPS transmitter as well as other conventional transmitters. Alternatively, an AM radio frequency that broadcasts time indexes may be used together with the receiver 118 to synchronize the clock that preferably is located within the router 510. Additionally, two or more AM radio stations may be used to synchronize clocks of a node 310. A network protocol may exist to assign a segment of time to each node 310 within the network 300. The protocol may require each node 310 to transmit only during their assigned time segment.

In this manner, there are no collisions because no two nodes 310 attempt to send a data packet across a link 410 at the same time. Similarly, during time segments that are not assigned to a particular node 310 the node 310 attempts to receive any incoming data packets from the node 310 assigned to the particular time segment. In other words, the nodes 310 all take turns ‘speaking’. And while one node 310 is ‘speaking’, all the other nodes 310 capable of receiving from, with links 410 to, the ‘speaking’ node are ‘listening’.

In one embodiment, the network address may correspond to a geographic location such as a longitude and latitude. A receiver 118, such as a GPS receiver 118, may provide the location of the antenna array 100 to the router 510. Alternatively, an AM radio frequency which broadcasts time indexes may be used to identify the location of the node 310 from a known local AM transmitter. Additionally, two or more AM radio stations may be used to determine the location of the antenna array 100. The geographic position information permits the router 510 to direct data packets in the particular directions in which the antennas 108 of the antenna array 100 extend. In this manner, the router 510 may route a data packet through particular links 410 and/or nodes 310 of the network 300.

In a preferred embodiment, each router 510 may include electrical components that allow the router 510 to perform its functions. These components are well known in the art and are not shown or described in detail to avoid obscuring aspects of the invention. Some of these components may include a processor, memory, antenna array 100 interface, computer network interface, and other like components. The router 510 may execute an operating system such as Windows®, Linux, or the like.

Additionally, each router 510 may execute software for implementing common network, intra-networking, and routing protocols, or proprietary network and routing protocols. The software may implement a common or proprietary routing algorithm. Routing algorithms are generally used to allow routers 510 in a network 300 to determine paths 420 between a source node 310 and a destination node 310 which are most efficient in terms of time, and network resources.

Generally, a routing algorithm may be implemented according to known protocols, such as a link state routing protocol or a distance-vector protocol. In these protocols a link 410 or node 310 may be associated with a cost or weight. The weight is generally a function of multiple weighting factors. A weighting factor is a characteristic regarding the node 310, link 410, or portion of a network 300. Weighting factors may include such things as the amount of data traffic that is passing through a node 310 or link 410, the distance the node 310 is for a point of presence (POP), reliability of a particular link 410, and other similar characteristics. The weight may be assigned to a link 410 or node 310 and updated periodically.

A routing algorithm may use the weighting factors to determine the most efficient path 420 from a source node 310 to a destination node 310. Alternatively, each node 310 may be required to calculate the best next link 410 to pass the data packet across, rather than computing the entire path 410 from the source node 310. Weighting factors may be analogized to monetary costs, temperature, or other cost-benefit analogies. In a preferred embodiment, the routing algorithm may determine a path 420 based on known temperature gradient formulas.

In a preferred embodiment, a weight or temperature is associated with each node 310. A source node 310 sends the data packet to its ‘warmest’ neighboring node 310. The neighboring node 310 then passes the data packet to the next ‘warmest’ neighbor node 310 closer to the destination node 310. In this manner, data is routed through nodes 310 best capable of handling the data. This provides for an efficient use of the network nodes 310 to provide for efficient routing of data packets.

One of skill in the art will readily recognize that the routing algorithm may be varied. The weighting factors and conditions used to determine an appropriate next link 410 may be varied. Factors relating to the physical and logical configuration of the routers 510, the network 300, as well as other factors may affect the logic and methods used in the routing algorithm. Different variations of the routing algorithm are considered within the scope of the present invention.

In one embodiment, the router 510 includes logic to manage changes in the configuration of the network 300. Changes in the network 300 may occur when a new node 310 is activated and seeks to operate on the network 300 or when a node 310 fails or is otherwise taken out of the network. The router 510 may include a configuration-monitoring algorithm or protocol that allows a node 310 to dynamically be added to, or removed from, the network.

For example, in one embodiment having nodes 310 with synchronized clocks, each node 310 may communicate according to a time segment protocol as discussed above. In one embodiment, around 80,000 time segments may be available. Initially, there may be multiple time segments allocated to each node 310. One or more time segments may be reserved such that a new node 310 may be installed and use the reserved time segment to request a permanent time segment. Then, the other nodes 310 may give up one or more of their multiple time segments to allow the new node 310 to use the time segments as permanent time segments. The protocol for determining which node 310 gives up which time segment may vary, but does not permit a node 310 to give up its only remaining time segment. In this manner, the wireless network 300 is capable of dynamically adapting to the addition of new nodes 310 to the network 300.

Likewise, when a node 310 leaves the network 300 either by signing off or by failure, the routers 510 in other nodes 310 of the network 300 may identify the removal of a node 310 through a timeout or other condition. Then, the configuration-monitoring algorithm of each node 310 may permit other nodes 310 to add the time segments which were previously allocated to the node 310 which was removed from the network 300.

The configuration-monitoring algorithm may be implemented according to various alternative conditions, methods, and protocols, each considered within the scope of the present invention. A configuration-monitoring algorithm may be implemented at each node 310 allowing the wireless network 300 to dynamically adapt to the addition or removal of nodes 310. The ability to adapt may be referred to as a dynamic airwave network (DAN). In this manner, the network 300 may be characterized as a Self-Configuring Wireless Internetwork (SCWI).

In a preferred embodiment, the router 510 may include logic, hardware, or software to allow the router 510 to control the size, and shape of a network cell 300 (See FIG. 3). The node 310 (See FIG. 3) which includes the router 510 may cooperate using the router 510 with other nodes 310 within a single network cell 300 to define the shape and size of the network cell 300. This may be accomplished by adjusting the power and direction in which nodes 310 of a particular network cell 300 communicate. Alternatively, the transceiver 116 may perform the functions of the router 510 described above.

Additionally, the router 510 may be configured to operate within a network cell 300 and use a common frequency and/or protocol for modulating transmission signals as those used by other routers 510 within the same network cell 300. The routers 510 may be configured to allow dynamic modification of the frequency and/or modulation protocols used within a particular network cell 300. Additionally, other control protocols and software within each node 310 of a network cell 300 may be changed dynamically by commands sent from a network control center (not shown). The network control center may organize one or more nodes 310 into a network cell 300.

Referring now generally to FIGS. 1-5, a device and system for providing a wireless high-speed communication network are illustrated. Various embodiments of the present invention provide an antenna array 100 configured to allow wireless signals to be passed in one of a plurality of directions about the antenna array 100. The antenna array 100 also allows for variable amounts of power to be directed in a particular direction to overcome obstructions between two antenna arrays 100. Additionally, the wireless signals are circularly polarized by the antennas 108 such that multipath interference is minimized.

A plurality of antenna arrays 100 may be organized in a mesh communication network 300. The mesh communication network 300 provides more reliable operation than traditional network topologies. The wireless nature of the network 300 allows for redundant links 410 to be established at minimal cost. The mesh communication network 300 may connect nodes 310 comprising personal computers 500 or LANs.

Each node 310 may comprise a router 510 configured to route data packets between source nodes 310 and destination nodes 310. The destination nodes 310 may be external nodes 330. The router 510 may execute particular routing algorithms and protocols to efficiently deliver data packets from one node 310 to another. The router 510 may also include network configuration-monitoring algorithms that allow the network 300 to dynamically adapt to the addition or removal of nodes 310.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the devices, methods and systems of the present invention disclosed herein without departing from the spirit and scope of the invention.

What is claimed is:

1. A multi-directional antenna array comprising:
a plurality of antennas extending radially about a central axis, each antenna being configured to transceive electromagnetic signals;
a transceiver in electrical communication with each antenna; and
a processor connected to the transceiver and configured to dynamically select an antenna for transmitting a signal in a particular direction and dynamically allocating power to the selected antenna to manipulate the strength of a transmitted signal.

2. The antenna array as in claim 1, wherein the processor is further configured to dynamically select an antenna for receiving a signal from a particular direction.

3. The antenna array as in claim 1, wherein the antennas are helical antennas.

4. The antenna array as in claim 1, wherein the antennas are horn antennas.

5. The antenna array as in claim 1, wherein the transceiver comprises a multiplexor and a demultiplexor for associating a transmission channel for each antenna.

6. The antenna array as in claim 1, wherein the processor comprises a multiplexor and a demultiplexor for associating a transmission channel for each antenna.

7. A multi-directional antenna array comprising:
a plurality of conductive planar segments connected to each other to define a polygon;
an antenna connected to each segment, each antenna configured to produce a circularly polarized electromagnetic signal; and
a transceiver in electrical communication with each antenna.

8. The antenna array as in claim 7, wherein the antennas are helical antennas.

9. The antenna array as in claim 7, wherein the antennas extend substantially perpendicular to their respective segment.

10. The antenna array as in claim 7, wherein the transceiver is capable of selecting an antenna for sending an electromagnetic signal.

11. The antenna array as in claim 10, wherein the transceiver is capable of directing a certain amount of power through the selected antenna.

12. The antenna array as in claim 11, wherein the certain amount of power ranges between one milliwatt to one watt.

13. The antenna array as in claim 7, wherein the transceiver comprises a multiplexor and a demultiplexor for associating a transmission channel for each antenna.

14. The antenna array as in claim 7, further comprising a processor, the processor comprising a multiplexor and a demultiplexor for associating a transmission channel for each antenna.

15. The antenna array as in claim 7, further comprising a planar top connected along its perimeter to a top edge of each segment.

16. The antenna array as in claim 7, further comprising a planar bottom connected to a bottom edge of each segment.

17. The antenna array as in claim 7, wherein the antennas are made at least in part from one of copper, iron, aluminum, gold, and silver.

18. The antenna array as in claim 7, wherein the antennas are configured to send and receive wireless communication data at a rate of at least twenty Mega bits per second (Mbps).

19. The antenna array as in claim 7, wherein the antennas are configured to transmit electromagnetic signals having a frequency of at least 5.7 Giga Hertz (GHz).

20. The antenna array as in claim 7, wherein the antenna array comprises twelve antennas connected to twelve segments.

21. A system for providing a wireless high-speed communication network comprising:
a plurality of network nodes capable of communicating with each other according to a mesh topology;
a plurality of multi-directional antenna arrays, wherein each antenna array couples to a respective node such that each node is capable of wireless communication with at least one other node; and
a gateway configured to allow the plurality of nodes to communicate with external nodes.

22. The system as in claim 21, wherein the gateway is coupled to a multidirectional antenna array.

23. The system as in claim 21, wherein the gateway is coupled to a second communication network, the second communication network comprising external nodes.

24. The system as in claim 21, wherein the external nodes are in a global information network.

25. The system as in claim 21, wherein the plurality of nodes are capable of dynamically integrating an added node.

26. The system as in claim 21, wherein the plurality of nodes are capable of dynamically adapting to the removal of a node.

27. The system as in claim 21, wherein the plurality of nodes comprise:
a router electronically connected to the antenna array; and
at least one communication device connected to the router.

28. The system as in claim 27, wherein the communication device comprises a computer.

29. The system as in claim 21, wherein the plurality of nodes further comprises a local area network connecting the router to the at least one communication device.

30. The system as in claim 21, wherein the router comprises a processor.

31. The system as in claim 21, wherein the router is configured to send and receive signals in a particular geographic direction.

32. The system as in claim 21, wherein each router further comprises a routing algorithm, the routing algorithm configured to establish a communication path between a source node and a destination node.

33. The system of claim 32, wherein the communication path is determined based on weighting factors associated with each node.

34. The system as in claim 21, wherein the plurality of nodes communicate with each other using a peer-to-peer architecture.

35. The system of claim 21, wherein each node comprises a network address.

36. The system as in claim 21, wherein each node comprises a clock and each antenna array comprises a receiver configured to allow the plurality of nodes to receive a synchronization signal and communicate using synchronized clocks.

37. The system as in claim 36, wherein the synchronization signal is generated by a global positioning system (GPS) transmitter.

38. The system as in claim 21, wherein each antenna array comprises a transceiver configured to send and receive electromagnetic signals.

39. The system as in claim 21, wherein each antenna array comprises,
a plurality of planar segments connected such that the planar segments define a polygon about a central axis, and wherein each segment comprises an exterior surface facing out from the central axis, and
a plurality of helical antennas wherein each helical antenna is coupled to a corresponding exterior surface.

40. The system as in claim 39, wherein each antenna array comprises twelve planar segments.

41. The system as in claim 21, wherein each antenna array comprises a plurality of horn antennas connected about a central axis such that each horn antenna extends in a different direction about the central axis.

42. The system as in claim 41, wherein each antenna array comprises 12 horn antennas.

43. The system as in claim 21, wherein each antenna array is made substantially of metal.

44. The system as in claim 21, wherein each antenna array is configured to transmit and receive communication data at a rate of at least twenty Mega bits per second (Mbps).

45. The system as in claim 21, wherein each antenna array comprises a central axis and a plurality of antennas directed to send and receive signals in a plurality of directions about the central axis.

46. The system as in claim 45, wherein the node selects from the plurality of directions a direction for sending each signal.

47. The system as in claim 21, wherein a number of nodes comprise a network cell, each node comprising a transceiver configured to adjust an amount of power directed through one or more of the antennas to define a particular size of the network cell.

48. The system as in claim 21, wherein a number of nodes comprise a network cell, each node comprising a transceiver configured to adjust an amount of power directed through one or more of the antennas to define a particular shape of the network cell.

49. The system as in claim 21, wherein a number of nodes comprise a network cell, and wherein nodes within the network cell are configured to dynamically adjust a transmission frequency used within the network cell.

50. The system as in claim 21, wherein a number of nodes comprise a network cell, and wherein nodes within the network cell are configured to dynamically change a modulation protocol used within the network cell.
